(19) United States
(12) Patent Application Publication
(10) Pub. No.: US 2022/0133059 A1
(43) Pub. Date: May 5, 2022

(54) Stackable Cutlery Utensil, Cutlery Dispenser and System for Dispensing Cutlery Utensils

(71) Applicant: Take It Once Pty. Ltd., Five Dock, New South Wales (AU)

(72) Inventor: Emmanuel Kastanias, Five Dock (AU)

(21) Appl. No.: 17/433,702

(22) PCT Filed: Feb. 18, 2020
(86) PCT No.: PCT/AU2020/050134

§ 371 Date: Aug. 25, 2021

(30) Foreign Application Priority Data
Feb. 26, 2019 (AU) 2019900608

(51) Int. Cl. A47F 1/06; A47G 21/00

(52) U.S. Cl. CPC A47F 1/065; A47G 21/00

(57) ABSTRACT

A stackable cutlery utensil, a cutlery dispenser and a system for dispensing cutlery utensils are provided. The stackable cutlery utensil comprises a head, an elongate handle, and at least one projection disposed on the elongate handle. The elongate handle comprises a neck portion attached to the head, and a free end portion. The elongate handle defines at least one longitudinally extending slot. The at least one projection is configured to be received by the at least one longitudinally extending slot of a further stackable cutlery utensil stacked adjacent the stackable cutlery utensil.

### CROSS-REFERENCE TO RELATED APPLICATIONS

This application is a 371 national phase application and claims priority to PCT Patent Application PCT/AU2020/050134, filed Feb. 18, 2020, which claims priority to Australian Patent Application 2019900608, filed Feb. 26, 2019, the content of each of which is hereby incorporated by reference.

### TECHNICAL FIELD

The present disclosure relates to a stackable cutlery utensil, a cutlery dispenser and a system for dispensing the stackable cutlery utensils.

### BACKGROUND

Disposable cutlery utensils, such as forks, knives, spoons, sporks or the like, are widely used in the quick service restaurant industry. Restaurant operators are often forced to leave disposable cutlery utensils in open self-serve trays or baskets for consumers to retrieve. This leads to a vast amount of disposable cutlery wastage as consumers often retrieve more than one cutlery utensil at a time. Such open self-serve trays may also present potential health concerns as consumers often touch or contact multiple cutlery utensils at once while removing a selected cutlery utensil from the self-serve tray. It may also be time-consuming for consumers to sort through multiple cutlery utensils in the self-serve trays to retrieve only what is necessary.

To address the above problems of open dispensing trays, restaurant operators have turned to enclosed cutlery dispensers. In known enclosed cutlery dispensers, cutlery utensils are typically loaded in a compartment and dispensed one at a time on command via operation of a lever, a button or other mechanical/electronic mechanism. A disadvantage of such known enclosed cutlery dispensers is that the internal mechanisms can be complex and comprise multiple moving parts, which may be subject to malfunction. Restaurant operator are therefore impacted by higher costs associated with maintaining such dispensers. A further disadvantage is that known enclosed cutlery dispensers may be bulky and may occupy a significant footprint on an already crowded countertop.

### Object

It is an object of the present disclosure to substantially overcome or ameliorate one or more of the above disadvantages.

### SUMMARY

In accordance with an aspect of the present disclosure, there is provided a stackable cutlery utensil, comprising:

a head;

an elongate handle comprising a neck portion attached to the head, and a free end portion, the elongate handle defining at least one longitudinally extending slot with a first end region adjacent to the neck portion and a second end region adjacent to the free end portion; and

at least one projection disposed on the elongate handle, wherein the at least one projection is configured to be received by the at least one longitudinally extending slot of a further stackable cutlery utensil stacked adjacent the stackable cutlery utensil such that the at least one projection is moveable from the first end region to the second end region of the at least one longitudinally extending slot of said further stackable cutlery utensil for abutment with the free end portion of the elongate handle of said further stackable cutlery utensil.

The at least one projection may extend downwardly from the elongate handle, and the further stackable cutlery utensil may be stacked below the stackable cutlery utensil. In some embodiments, the at least one projection may be disposed below the first end region. In some embodiments, the at least one projection may be disposed directly above the at least one projection of said further stackable cutlery utensil when the at least one projection is in the first end region of the at least one longitudinally extending slot of said further stackable cutlery utensil.

The at least one projection may be triangular in shape. In some embodiments, the at least one projection may have a height that is substantially the same as a height of the at least one longitudinally extending slot. In further embodiments, the at least one projection may have a transverse width that is substantially the same as a transverse width of the at least one longitudinally extending slot.

The elongate handle may define two longitudinally extending slots, and the at least one projection may comprise two projections. Each of the projections may extend downwardly from the elongate handle, and the further stackable cutlery utensil may be stacked below the stackable cutlery utensil. In some embodiments, each of the projections may be disposed below the first end region of a respective longitudinally extending slot. In some embodiments, each of the projections may be disposed directly above a respective projection of said further stackable cutlery utensil when each of the projections is in the first end region of a respective longitudinally extending slot of said further stackable cutlery utensil. In some embodiments, the stackable cutlery utensil may further comprise two abutment projections disposed on the elongate handle. Each of the abutment projections may be disposed above the second end region and may extend upwardly from the elongate handle.

The elongate handle may have an upper planar surface and a lower planar surface configured to abut with the upper planar surface of said further stackable cutlery utensil.

The head may have a lowermost portion disposed on or above a plane defined by the lower planar surface.

The head and the elongate handle may be integrally formed.

The at least one projection and the elongate handle may be integrally formed.

The head may comprise one or more of a tine portion, a blade portion and a bowl portion.

In accordance with another aspect of the present disclosure, there is provided a cutlery dispenser, comprising:

a housing for storing a plurality of stacked cutlery utensils therein, the housing comprising a front wall and an upper wall defining an outlet adjacent to the front wall; and

a biasing member disposed in the housing and configured to urge the stacked cutlery utensils towards the upper wall so that an uppermost stacked cutlery utensil of said stacked cutlery utensils abuts the upper wall and said uppermost stacked cutlery utensil is movable forwardly to the outlet for dispensing thereof.

In accordance with a further aspect of the present disclosure, there is provided a cutlery dispenser, comprising:

a housing for storing a plurality of stackable cutlery utensils in a stacked arrangement, each of said stackable cutlery utensils according to any of the above embodiments, the housing defining an upper outlet;

a biasing member disposed in the housing and configured to urge said stackable cutlery utensils upwardly; and

at least one protrusion disposed in the outlet and having a rearwardly-facing ramp surface configured to engage with the head of an uppermost stackable cutlery utensil of said stackable cutlery utensils stored in the housing as the uppermost stackable cutlery utensil moves forwardly and cause the at least one projection of the stackable cutlery utensil to separate from the longitudinally extending slot of a further stackable cutlery utensil stacked below the uppermost stackable cutlery utensil.

In accordance with yet another aspect of the present disclosure, there is provided a system for dispensing cutlery utensils, the system comprising:

the cutlery dispenser according to any of the above embodiments; and

a plurality of stacked cutlery utensils disposed in the cutlery dispenser, said stacked cutlery utensils comprises an uppermost cutlery utensil and a further cutlery utensil stacked below said uppermost cutlery utensil,

wherein the uppermost cutlery utensil is configured to be moveable forwardly to the outlet for dispensing thereof such that the further cutlery utensil abuts the upper wall and is moveable forwardly for subsequent dispensing thereof.

The biasing member may be a spring.

### BRIEF DESCRIPTION OF DRAWINGS

Embodiments of the present disclosure will now be described hereinafter, by way of examples only, with reference to the accompanying drawings, in which:

FIG. 1 is a perspective view of an embodiment of a stackable cutlery utensil;

FIG. 2 is a side view of the stackable cutlery utensil of FIG. 1;

FIG. 3 is a front view of the stackable cutlery utensil of FIG. 1;

FIG. 4 is a perspective view of the stackable cutlery utensil of FIG. 1 in a stacked arrangement, with the uppermost stackable cutlery utensil displaced for illustrative purposes only;

FIG. 5 is a perspective view of an embodiment of a cutlery dispenser, with a first top wall in the closed position and a second top wall in the open position;

FIG. 6 is a top view of the cutlery dispenser of FIG. 5;

FIG. 7 is a perspective view of the cutlery dispenser of FIG. 5 loaded with the stackable cutlery utensils of FIG. 1;

FIG. 8 is a top view of the cutlery dispenser of FIG. 5 loaded with the stackable cutlery utensils of FIG. 1;

FIG. 9 is a cross-sectional side view of the cutlery dispenser of FIG. 5 loaded with the stackable cutlery utensils of FIG. 1, with an uppermost stackable cutlery utensil in a dispensing position;

FIG. 10 is a top view of the cutlery dispenser of FIG. 5 loaded with the stackable cutlery utensils of FIG. 1, with an uppermost stackable cutlery utensil in a dispensing position;

FIG. 11 is a cross-sectional side view of the cutlery dispenser of FIG. 5 loaded with the stackable cutlery utensils of FIG. 1, with an uppermost stackable cutlery utensil being dispensed;

FIG. 12 is perspective view of another embodiment of a stackable cutlery utensil;

FIG. 13 is a side view of the stackable cutlery utensil of FIG. 12;

FIG. 14 is a perspective view of the stackable cutlery utensil of FIG. 12 in a stacked arrangement, with the uppermost stackable cutlery utensil displaced for illustrative purposes only;

FIG. 15 is a perspective view of another embodiment of a cutlery dispenser;

FIG. 16 is a top view of another embodiment of a stackable cutlery utensil; and

FIG. 17 is a side view of the stackable cutlery utensil of FIG. 16.

### DESCRIPTION OF EMBODIMENTS

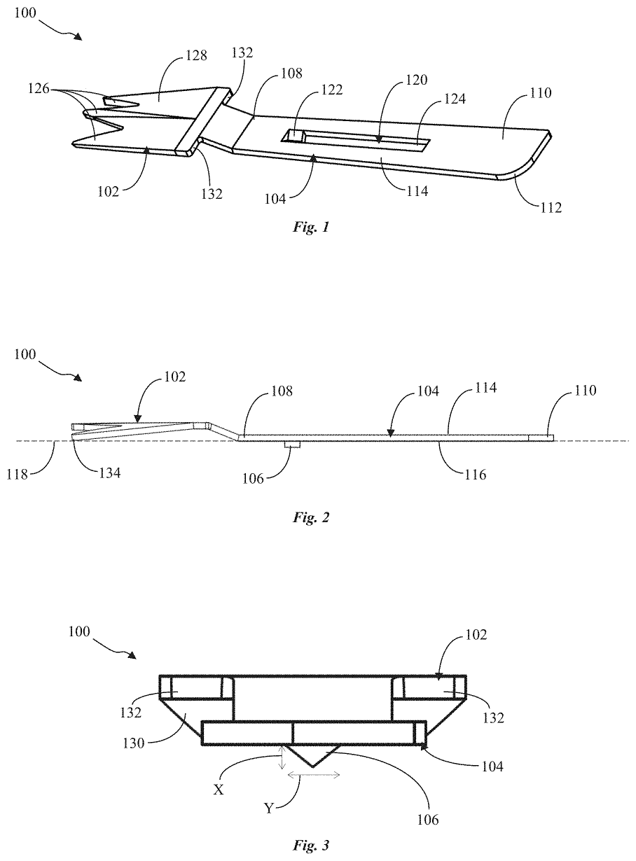

FIGS. 1 to 3 show a stackable cutlery utensil 100 according to an embodiment of the present disclosure. In this embodiment, the stackable cutlery utensil 100 is in the form of a fork. The stackable cutlery utensil 100 comprises a head 102, an elongate handle 104, and a projection 106 extending downwardly from the handle 104. The handle 104 has a neck portion 108 attached to the head 102, a free end portion 110 with a curved edge 112, an upper planar handle surface 114, and a lower planar handle surface 116 defining a plane 118. The lower handle surface 116 is configured to abut with the upper handle surface 114 of a further stackable cutlery utensil 100 when the further stackable cutlery utensil 100 is stacked below the stackable cutlery utensil 100. The handle 104 defines a longitudinally extending slot 120 with a first end region 122 adjacent to the neck portion 108 and a second end region 124 adjacent to the free end portion 110.

The projection 106 is triangular in shape (FIG. 3) and is disposed below the first end region 122. The projection 106 is configured to be received by the longitudinally extending slot 120 of the further stackable cutlery utensil 100 such that the projection 106 is moveable from the first end region 122 to the second end region 124 of the longitudinally extending slot 120 of the further stackable cutlery utensil 100 for abutment with the free end portion 110 of the handle 104 of the further stackable cutlery utensil 100. When the projection 106 is in the first end region 122 of the slot 120 of the further stackable cutlery utensil 100, the projection 106 is disposed directly above the projection 106 of the further stackable cutlery utensil 100. The projection 106 is sized and shaped to be fittingly received by the slot 120 of the further stackable cutlery utensil 100. The projection 106 has a height X that is substantially the same as a height of the slot 120. The projection 106 also has a transverse width Y that is substantially the same as the transverse width of the slot 120. In this embodiment, the projection 106 and the slot 120 both have a height of 1.8 mm and a transverse width of 5 mm. The projection 106 and the handle 104 are integrally formed and may be made from wood, a plastics material, a metallic material, or the like.

The head 102 has three tine portions 126, an upper head surface 128, a lower head surface 130 configured to abut with the upper head surface 128 of the further stackable cutlery utensil 100, and two flange portions 132. The head 102 has a lowermost portion 134 that is disposed on or above the plane 118. This is to ensure that the head 102 does not contact the further stackable cutlery utensil 100. In this embodiment, the lowermost portion 134 is at two points on the outer tine portions 126, which is disposed on the plane 118. The head 102 and the handle 104 are integrally formed and may be made from wood, a plastics material, a metallic material, or the like.

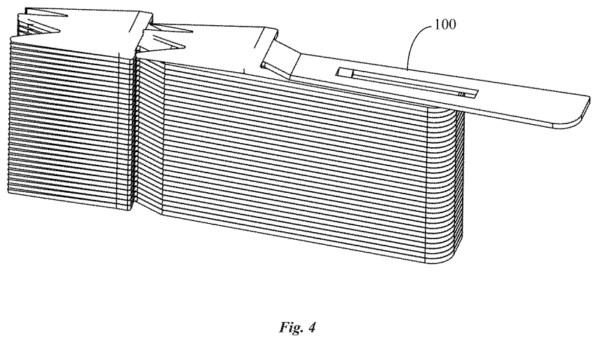

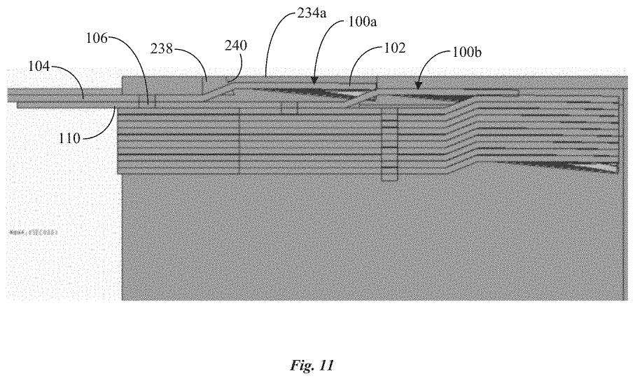

FIG. 4 shows an example of the stackable cutlery utensil 100 provided in a stacked arrangement, where the lower handle surface 116 and the lower head surface 130 of the stackable cutlery utensil 100 abuts with the respective upper handle surface 114 and the upper head surface 128 of the further stackable cutlery utensil 100 stacked therebelow. Further, in the stacked arrangement, the slot 120 of the remaining stackable cutlery utensil 100 receives the projection 106 of the above stackable cutlery utensil 100 in the first end region 122, as can be seen in FIG. 11. The stackable cutlery utensils 100 are nested together and may be surrounded by a removable band (not shown).

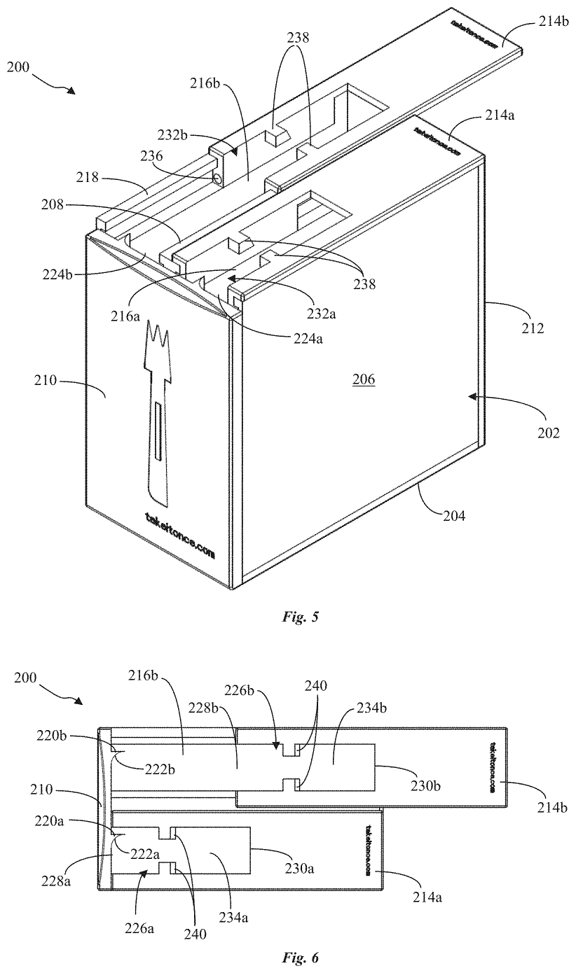

FIGS. 5 and 6 show a cutlery dispenser 200 according to an embodiment of the present disclosure. The cutlery dispenser 200 is suitable for use with the stackable cutlery utensil 100 shown in FIGS. 1 to 3. The cutlery dispenser 200 comprises a housing 202 having a base 204, first and second side walls 206, 208 extending upwardly from the base 204, front and rear walls 210, 212, and a first top wall 214a, together defining a first internal chamber 216a for storing a plurality of stackable cutlery utensils 100. The housing 202 further comprises a third side wall 218 extending from the base 204, and second top wall 214b, defining a second internal chamber 216a for storing a plurality of stackable cutlery utensil 100.

With reference to FIG. 6, the front wall 210 has first and second guide protrusions 220a, 220b extending rearwardly into the first and second internal chambers 216a, 216b, respectively. Each guide protrusion 220a, 220b has an abutment surface 222a, 222b configured to abut with the curved edge 112 of the stackable cutlery utensil handle 104 so as to guide the stackable cutlery utensil 100 in the internal chambers 216a, 216b. The abutment surfaces 222a, 222b are shaped to correspond with the curved edge 112 of the stackable cutlery utensil handle 104. In this embodiment, the height of the front wall 210 is less than the height of the side walls 206, 208, 218, and the clearance height between the front wall 210 and the side walls 206, 208, 218 is 3.6 mm.

The top walls 214a, 214b each have a longitudinally extending slot 226a, 226b with a first slot end 228a, 228b and second slot end 230a, 230b. The top walls 214a, 214b are each longitudinally moveable between a closed position in which the first slot end 228a, 228b is substantially adjacent the front wall 210, and an open position in which the second slot end 230a, 230b is substantially adjacent the rear wall 212. The slot 226a of the first top wall 214a defines a first outlet 232a with a forwardly-facing opening 224a and an upwardly-facing opening 234a. Similarly, the slot 226b of the second top wall 214b defines a second outlet 232b with a forwardly-facing opening 224b and an upwardly-facing opening 234b. Each of the upwardly-facing openings 234a, 234b has dimensions that correspond with the dimensions of the head 102 of the stackable cutlery utensil 100 so as to allow the head 102 to move upwardly therethrough. Further, each of the forwardly-facing openings 224a, 224b has dimensions that correspond with the dimensions of the handle 104 of the stackable cutlery utensil 100 so as to allow the handle 104 to move longitudinally therethrough. In the open position, the slots 226a, 226b of the top walls 214a, 214b are also inlets.

In some embodiments, the front wall 210 and the top walls 214a, 214b may comprise one or more corresponding magnets 236 disposed thereon for holding the top walls 214a, 214b in the closed position.

The housing 202 further comprises at least one outlet protrusion 238 disposed in each of the slots 226a, 226b and having a rearwardly-facing ramp surface 240 that is configured to engage the head 102 of the stackable cutlery utensil 100 as the stackable cutlery utensil 100 moves forwardly causing the projection 106 of the stackable cutlery utensil 100 to separate from the slot 120 of the further stackable cutlery utensil 100. In this embodiment, the housing 202 has two opposed outlet protrusions 238 extending from each of the top walls 214a, 214b. The outlet protrusions 238 are spaced from the first slot ends 228a, 228b and adjacent to the upwardly-facing openings 234a, 234b.

The housing 202 may be made from wood, a plastics material, a metallic material, or the like.

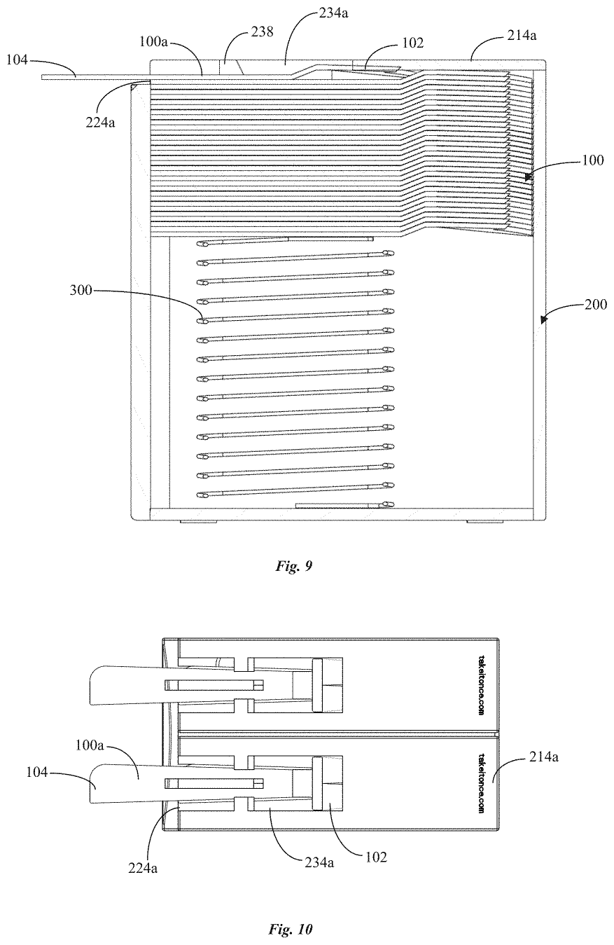

The cutlery dispenser 200 further comprises a biasing member 300 disposed in each of the internal chambers 216a, 216b. The biasing member 300 is configured to urge the stackable cutlery utensils 100 upwardly, as shown in FIG. 9. In this embodiment, the biasing member 100 is a spring.

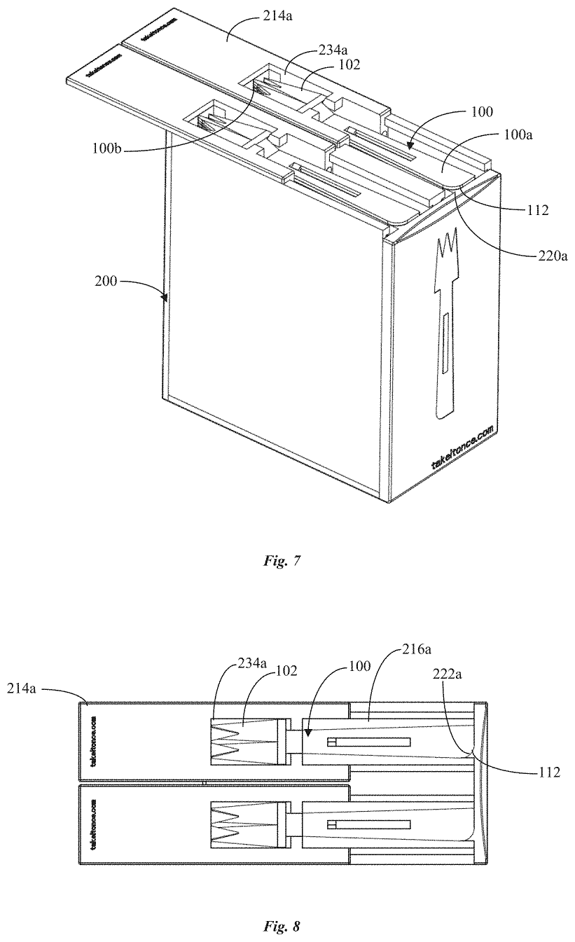

An exemplary use of the cutlery dispenser 200 will now be described with reference to FIGS. 7 to 11. For ease of referencing, use of the cutlery dispenser 200 will only be described with respect to the first internal chamber 216a and the components of the cutlery dispenser 200 associated therewith. It will be appreciated, however, that the cutlery dispenser 200 can be used in a similar manner with respect to the second internal chamber 216b and the components of the cutlery dispenser 200 associated therewith.

The first top wall 214a is moved rearwardly to the open position. The stackable cutlery utensils 100 are inserted downwardly into the first internal chamber 216a in the stacked arrangement such that the head 102 of the stackable cutlery utensils 100 passes through the upwardly-facing opening 234a and the curved edge 112 of the stackable cutlery utensils 100 abuts with the abutment surface 222a of the first guide protrusion 220a, as shown in FIGS. 7 and 8. The stackable cutlery utensils 100 are now in a stacked position. The first guide protrusion 220a ensures that the stackable cutlery utensils 100 are inserted in the first internal chamber 216a in the correct orientation. The stackable cutlery utensils 100 has an uppermost stackable cutlery utensil 100a and a further stackable cutlery utensil 100b stacked therebelow. The uppermost stackable cutlery utensil 100a and the further stackable cutlery utensil 100b are identical to the stackable cutlery utensil 100 shown in FIGS. 1 to 3 and like features have been indicated with like reference numerals. The removable band is then removed from the stackable cutlery utensils 100 and the first top wall 214a is moved forwardly to the closed position. The uppermost stackable cutlery utensil 100a is then moved forwardly to a dispensing position in which the head 102 of the uppermost stackable cutlery utensil 100a abuts the top wall 214a and the handle 104 of the uppermost stackable cutlery utensil 100a extends through the forwardly-facing opening 224a for grabbing by a user, as shown in FIGS. 9 and 10. In this embodiment, the head 102 of the uppermost stackable cutlery utensil is also partially visible through the upwardly-facing opening 234a.

Turning now to FIG. 11, to dispense the uppermost stackable cutlery utensil 100a, a user grabs the handle 104 of the uppermost stackable cutlery utensil 100a and moves the uppermost stackable cutlery utensil 100a forwardly such that the handle 104 extends further through the forwardly-facing opening 224a. The outlet protrusions 238 engage the flange portions 132 of the uppermost stackable cutlery utensil head 102, as the uppermost stackable cutlery utensil 100a moves forwardly, causing the projection 106 of the uppermost stackable cutlery utensil 100a to separate from the slot 120 of the further stackable cutlery utensil 100b. The head 102 of the uppermost stackable cutlery utensil 100a moves upwardly along the ramp surface 240 and through the upwardly-facing opening 234a, thereby dispensing the uppermost stackable cutlery utensil 100a from the cutlery dispenser 200. Forward movement of the uppermost stackable cutlery utensil 100a moves the projection 106 of the uppermost stackable cutlery utensil 100a from the first end region 122 to the second end region 124 of the slot 120 of the further stackable cutlery utensil 100b such that the projection 106 abuts the free end portion 110 of the further stackable cutlery utensil handle 104, thus causing the further stackable cutlery utensil 100b to move forwardly. The biasing member 300 also assists with moving the further stackable cutlery utensil 100b from the stacked position to the dispensing position, ready for dispensing. Separation of the projection 106 of the uppermost stackable cutlery utensil 100a from the slot 120 of the further stackable cutlery utensil 100b by the outlet protrusions 238 limits continual forward movement of the further stackable cutlery utensil 100b, thus ensuring that only the uppermost stackable cutlery utensil 100a is dispensed.

In this embodiment, the forwardly-facing opening 224a allows a maximum of two handles 104 to extend therethrough, due to the clearance height between the front wall 210 and the first and second side walls 206, 208 being 4 mm and the height of the handle 104 of the stackable cutlery utensil 100 being 2 mm. This ensures that the remaining stackable cutlery utensils 100 cannot be forced out of the cutlery dispenser 200, even by way of friction, for example.

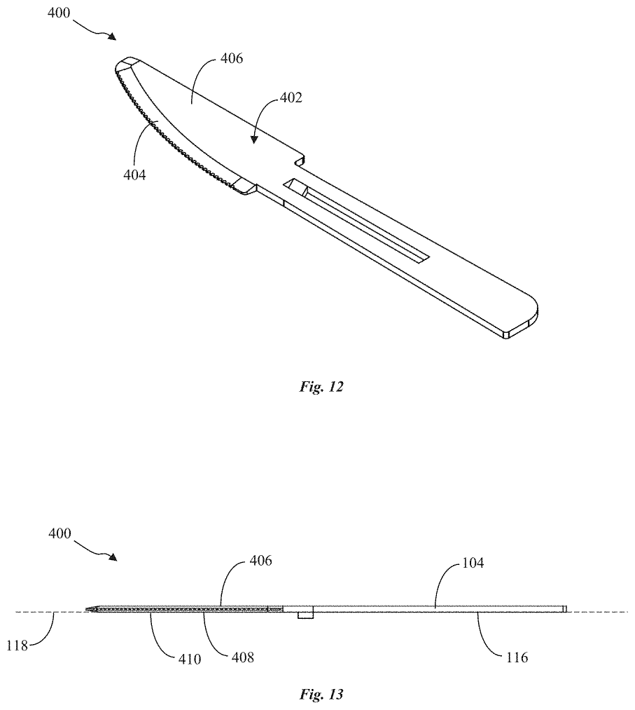

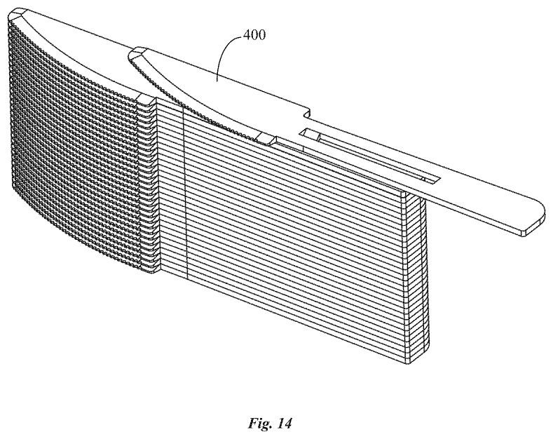

FIGS. 12 and 13 show another embodiment of a stackable cutlery utensil 400. The stackable cutlery utensil 400 is similar to the stackable cutlery utensil 100 shown in FIGS. 1 to 3 and like features have been indicated with like reference numerals. In this embodiment, however, the stackable cutlery utensil 400 is in the form of a knife. The head 402 has a blade portion 404, an upper planar surface 406, and a lower planar surface 408 configured to abut with the upper surface 406 of a further stackable cutlery utensil 400 stacked below the stackable cutlery utensil 400. The lowermost portion 410 of the head 402 is on the lower surface 408, which is disposed on the plane 118 defined by the lower surface 116 of the handle 104. The stackable cutlery utensil 400 may also be provided in a stacked arrangement such that the stackable cutlery utensils 400 are nested together, as shown in FIG. 14.

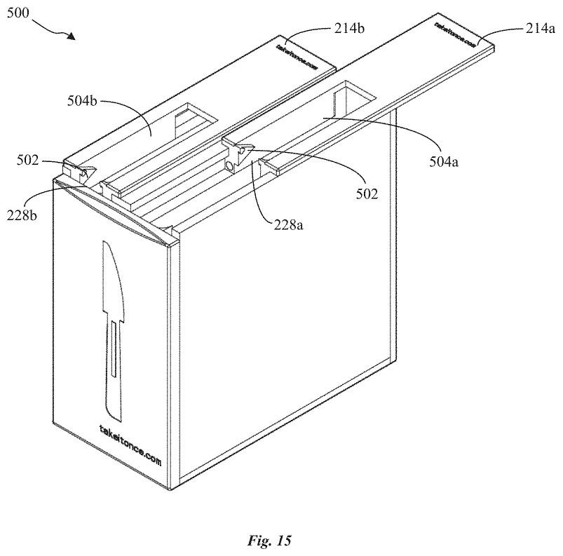

FIG. 15 shows another embodiment of a cutlery dispenser 500 for use with the stackable cutlery utensil 400 of FIGS. 12 and 13. The cutlery dispenser 500 is similar to the cutlery dispenser 200 shown in FIGS. 5 and 6 and like features have been indicated with like reference numerals. However, in this embodiment, the outlet protrusions 502 are adjacent both the first slot ends 228a, 228b and the upwardly-facing openings 504a, 504b. Each of the upwardly-facing openings 504a, 504b has dimensions that correspond with the dimensions of the head 402 of the stackable cutlery utensil 400 so as to allow the head 400 to move upwardly therethrough.

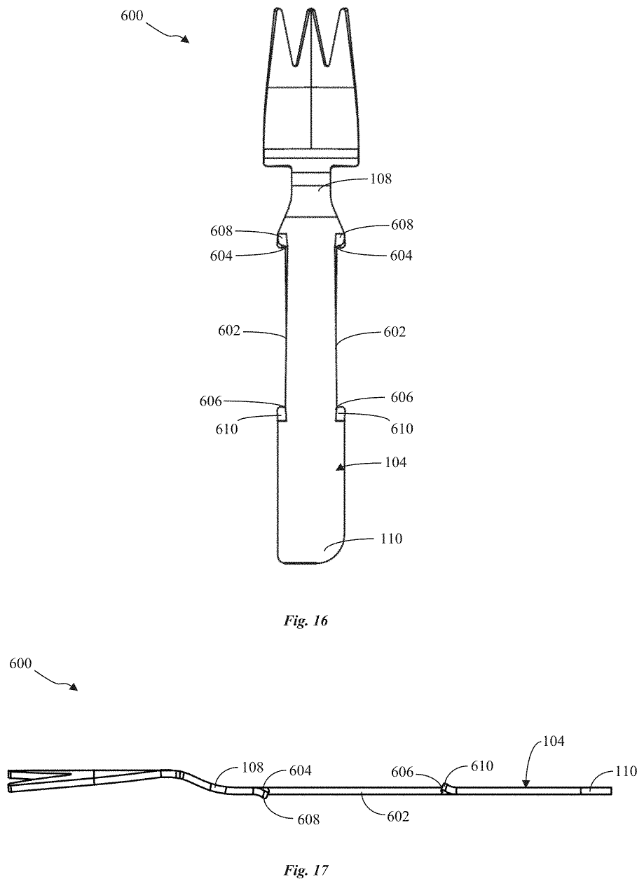

FIGS. 16 and 17 show a further embodiment of a stackable cutlery utensil 600. The stackable cutlery utensil 600 is similar to the stackable cutlery utensil 100 shown in FIGS. 1 to 3 and like features have been indicated with like reference numerals. In this embodiment, however, the handle 104 defines two longitudinally extending slots 602 disposed on opposed sides of the handle 104. Each of the longitudinally extending slots 602 has a first end region 604 adjacent to the neck portion 108 and a second end region 606 adjacent to the free end portion 110. Further, the stackable cutlery utensil 600 comprises two projections 608 extending downwardly from the handle 104. Each of the projections 608 is disposed below the first end region 604 of respective longitudinally extending slots 602. Moreover, the stackable cutlery utensil 600 comprises two abutment projections 610 extending upwardly from the handle 104. In use, the projections 610 are configured to abut with the respective projections 608 of a further stackable cutlery utensil 600 stacked above the stackable cutlery utensil 600, to facilitate forward movement of the stackable cutlery utensil 600. The stackable cutlery utensil 600 is configured to be stacked and dispensed in a similar manner to that for the stackable cutlery utensil 100. In further embodiments, the stackable cutlery utensil 600 may be in the form of a knife, in which the head has a blade portion.

In further embodiments, the stackable cutlery utensil may be in the form of a spoon, in which the head has a bowl portion. In yet further embodiments, the stackable cutlery utensil may be in the form of chopsticks. In further embodiments, the stackable cutlery utensil may be in the form of a drink stirrer.

In yet a further embodiment, a stackable cutlery utensil may be configured to be dispensed from a bottom outlet, rather than through the top panel described above. In this embodiment, the stackable cutlery utensil may comprise a head, an elongate handle defining a longitudinally extending slot, and a projection extending upwardly from the handle. The stackable cutlery utensil of this embodiment may be used with a corresponding cutlery dispenser having a housing with a bottom outlet through which the stackable cutlery utensil may be dispensed. It will be appreciated that stackable cutlery utensils may be urged to the bottom outlet by way of gravity, thus not requiring a separate biasing member. It will also be appreciated that the bottom outlet may be raised from the ground so as to allow the stackable cutlery utensils to be taken by a user.

In other embodiments, the top lid may be hingedly connected to the front wall, the first wall, the second wall, or either of the rear walls.

The above described embodiments have numerous advantages. The stackable cutlery utensils are able to be dispensed one at a time, which vastly reduces cutlery wastage. Further, a user only contacts the uppermost stackable cutlery utensil to be dispensed without the need to operate a lever, a button or other mechanical/electronic mechanism, and the remaining stackable cutlery utensils are enclosed within the housing of the cutlery dispenser, thereby eliminating potential health issues associated with cross-contamination. The above described cutlery dispensers are also simple and do not require complex or multiple moving parts, which makes the cutlery dispensers less prone to malfunction, thus reducing manufacturing and maintenance costs. The above described cutlery dispensers also occupy less space on the countertop, and the dual internal chambers allow multiple users to dispense a stackable cutlery utensil one at a time.

It will be appreciated by persons skilled in the art that numerous variations and/or modifications may be made to the above-described embodiments, without departing from the broad general scope of the present disclosure. The present embodiments are, therefore, to be considered in all respects as illustrative and not restrictive.

1. A stackable cutlery utensil, comprising:
a head;
an elongate handle comprising a neck portion attached to the head, and a free end portion, the elongate handle defining at least one longitudinally extending slot with a first end region adjacent to the neck portion and a second end region adjacent to the free end portion; and
at least one projection disposed on the elongate handle, wherein the at least one projection is configured to be received by the at least one longitudinally extending slot of a further stackable cutlery utensil stacked adjacent the stackable cutlery utensil such that the at least one projection is moveable from the first end region to the second end region of the at least one longitudinally extending slot of said further stackable cutlery utensil for abutment with the free end portion of the elongate handle of said further stackable cutlery utensil.

2. The stackable cutlery utensil according to claim 1, wherein the at least one projection extends downwardly from the elongate handle, and wherein the further stackable cutlery utensil is stacked below the stackable cutlery utensil.

3. The stackable cutlery utensil according to claim 2, wherein the at least one projection is disposed below the first end region.

4. The stackable cutlery utensil according to claim 3, wherein the at least one projection is disposed directly above the at least one projection of said further stackable cutlery utensil when the at least one projection is in the first end region of the longitudinally extending slot of said further stackable cutlery utensil.

5. The stackable cutlery utensil according to claim 1, wherein the at least one projection is triangular in shape.

6. The stackable cutlery utensil according to claim 1, wherein the at least one projection has a height that is substantially the same as a height of the at least one longitudinally extending slot.

7. The stackable cutlery utensil according to claim 1, wherein the at least one projection has a transverse width that is substantially the same as a transverse width of the at least one longitudinally extending slot.

8. The stackable cutlery utensil according to claim 1, wherein the elongate handle defines two longitudinally extending slots, and wherein the at least one projection comprises two projections.

9. The stackable cutlery utensil according to claim 8, wherein each of the projections extends downwardly from the elongate handle, and wherein the further stackable cutlery utensil is stacked below the stackable cutlery utensil.

10. The stackable cutlery utensil according to claim 9, wherein each of the projections is disposed below the first end region of a respective longitudinally extending slot.

11. The stackable cutlery utensil according to claim 10, wherein each of the projections is disposed directly above a respective projection of said further stackable cutlery utensil when each of the projections is in the first end region of a respective longitudinally extending slot of said further stackable cutlery utensil.

12. The stackable cutlery utensil according to claim 8, further comprising two abutment projections disposed on the elongate handle, wherein each of the abutment projections is disposed above the second end region and extends upwardly from the elongate handle.

13. The stackable cutlery utensil according to claim 2, wherein the elongate handle has an upper planar surface and a lower planar surface configured to abut with the upper planar surface of said further stackable cutlery utensil.

14. The stackable cutlery utensil according to claim 13, wherein the head has a lowermost portion disposed on or above a plane defined by the lower planar surface.

15. The stackable cutlery utensil according to claim 1, wherein the head and the elongate handle are integrally formed.

16. The stackable cutlery utensil according to claim 1, wherein the at least one projection and the elongate handle are integrally formed.

17. The stackable cutlery utensil according to claim 1, wherein the head comprises one or more of a tine portion, a blade portion and a bowl portion.

18. A cutlery dispenser, comprising:
a housing for storing a plurality of stacked cutlery utensils therein, the housing comprising a front wall and an upper wall defining an outlet adjacent to the front wall;
a biasing member disposed in the housing and configured to urge the stacked cutlery utensils towards the upper wall so that an uppermost cutlery utensil of the stacked cutlery utensils abuts the upper wall and the uppermost cutlery utensil is moveable forwardly to the outlet for dispensing thereof.

19. A system for dispensing cutlery utensils, the system comprising:
the cutlery dispenser according to claim 18; and
a plurality of stacked cutlery utensils disposed in the cutlery dispenser, the stacked cutlery utensils comprises an uppermost cutlery utensil and a further cutlery utensil stacked below said uppermost cutlery utensil,
wherein the uppermost cutlery utensil is configured to be moveable forwardly to the outlet for dispensing thereof such that the further cutlery utensil abuts the upper wall is moveable forwardly for subsequent dispensing thereof.
